(19) United States
(12) Patent Application Publication
(10) Pub. No.: US 2025/0196298 A1
(43) Pub. Date: Jun. 19, 2025

(54) APPARATUS FOR TIGHTENING THREADED FASTENERS

(71) Applicant: HYTORC Division UNEX Corporation, Mahwah, NJ (US)

(72) Inventors: Michael F. Dolan, Manasquan, NJ (US); Eric P. Junkers, Mahwah, NJ (US)

(73) Assignee: HYTORC Division UNEX Corporation, Mahwah, NJ (US)

(21) Appl. No.: 18/847,841

(22) PCT Filed: Mar. 17, 2023
(86) PCT No.: PCT/US2023/064630

§ 371 Date: Sep. 17, 2024

Related U.S. Application Data
(60) Provisional application No. 63/320,972, filed on Mar. 17, 2022.

(51) Int. Cl. B25B 13/48; F16B 39/10

(52) U.S. Cl. CPC B25B 13/481; F16B 39/103

(57) ABSTRACT

Disclosed herein is an apparatus for tightening threaded fasteners comprising a folding locking tab having a first tab and a second tab. The first tab and the second tab are movable between a locked position and an unlocked position along an axis transverse to a plane defined by a bendable living hinge. The first tab having a rotational coupling part in the center of the first tab having a first locking tab slot present on a primary end of the first tab and a second locking tab slot present on a secondary end of the first tab. The second tab having a lobe in the middle of the second tab, the lobe having a predetermined shape is configured for rotational coupling of the folding locking tab with a washer associated with the nut. The second tab having a first snap protruded at a first end of the second tab.

### CROSS REFERENCE TO RELATED APPLICATIONS AND PATENTS

This Application either claims priority to and/or is either a continuation patent application or a continuation-in-part application of the following commonly owned and/or co-pending patent applications, entire copies of which are incorporated herein by reference: U.S. Application Ser. No. 63/320,972, having Filing Date of 22 Mar. 2023, entitled “APPARATUS FOR TIGHTENING THREADED FASTENERS”.

### TECHNICAL FIELD

The disclosed invention pertains generally to apparatus for installing fasteners. More particularly, embodiments of the disclosed invention provide an apparatus for tightening threaded fasteners.

### BACKGROUND ART

In conventional bolting applications, threaded fasteners like bolts, studs, nuts, and washers are well-known and used. In order to maintain and repair industrial applications, these threaded fasteners must first be loosened and then tightened. Because of things like protruding threads, small clearances, and obstructions in the way of bolting applications, these fasteners are frequently completely inaccessible or impossible to reach with tools that an operator is likely to have on hand.

Adding surface roughness properties to load bearing areas on torqued fasteners has been recognized to provide anti-loosening properties. These anti-loosening properties are achieved by adding surface roughness areas to static and sliding areas of the washer, bolt, or nut. These surface roughness features will create resistance to loosening by creating a friction or embedment derived rotational coupling with a stationary surface such as a flange face. A washer with surface roughness on both faces can pass turning resistance gained from a stationary surface through to a fastener that otherwise has the propensity to rotate. A nut or bolt head can also be rotationally coupled to a stationary bearing face with surface roughness on the load bearing face. Surface roughness features have significant benefits for preventing loosening in bolted joints.

However, surface roughness also introduces drawbacks during the fastener preloading process. One drawback is reduced torque to load efficiency as a result of increased friction during sliding. Surface roughness areas are also vulnerable to damage under the influence of friction during the torquing process.

This disclosure teaches both method and apparatus for creating surface roughness derived anti-loosening fastening systems without adding surface roughness to the sliding fastener surfaces.

Thus, in light of the above-stated discussion, there is an urgent need for a technical solution that overcomes the above-stated limitations. The present disclosure focuses on an apparatus for tightening threaded fasteners.

### SUMMARY OF THE DISCLOSURE

The following is a summary description of illustrative embodiments of the invention. It is provided as a preface to assist those skilled in the art to more rapidly assimilate the detailed design discussion which ensues and is not intended in any way to limit the scope of the claims which are appended hereto in order to particularly point out the invention.

According to illustrative embodiments, the present disclosure focuses on an apparatus for tightening threaded fasteners which overcome the above mentioned disadvantages or provide the users with a useful or commercial choice.

According to the first aspect of the present disclosure, an apparatus for tightening threaded fasteners is disclosed herein. The apparatus comprising a folding locking tab having a first tab and a second tab. The first tab and the second tab are movable between a locked position and an unlocked position along an axis transverse to a plane defined by a bendable living hinge. The first tab having a rotational coupling part in the center of the first tab. Further, the rotational coupling part having a predefined shape allowing rotational coupling and engagement with corners of a nut from a bolted joint for tightening or loosening operation. The first tab having a first locking tab slot present on a primary end of the first tab and a second locking tab slot present on a secondary end of the first tab. the second tab having a lobe in the middle of the second tab. The lobe comprises a predetermined shape is configured for rotational coupling of the folding locking tab with a washer associated with the nut that includes an interface similar to an interface of the lobe. The second tab having a first snap protruded at a first end of the second tab. Furthermore, the first snap is configured to engage and lock with the first locking tab slot when the first tab and the second tab is folded about the bendable living hinge.

In one embodiment of the present invention, the apparatus further comprising a second snap protruded at a second end of the second tab is configured to engage and lock with the second locking tab slot present on a secondary end of the first tab when the first tab and the second tab is folded about the bendable living hinge.

In one embodiment of the present invention, the second end of the second tab is a pronounced or pointed shape that is configured for a rotational positional reference during installation and inspection of the apparatus.

In one embodiment of the present invention, the folding locking tab is made of a material comprises a polymeric material such as plastic, rubber, a malleable metal such as aluminum, and so forth.

In one embodiment of the present invention, the predefined shape of the rotational coupling part comprises a plurality of small creases or edges.

In one embodiment of the present invention, the bendable living hinge is malleable to allow for rotational indexing of the rotational coupling part in relation to the lobe remaining on the same axis.

In one embodiment of the present invention, the bendable living hinge is created from facets or folds.

In one embodiment of the present invention, the first locking tab slot and the second locking tab slot are configured to allow space for the rotational indexing of the rotational coupling part in relation to the lobe.

In an embodiment of the present invention, the rotational coupling part in the center of the first tab and the lobe in the middle of the second tab are centered about the same axis with rotational coupling features.

In an embodiment of the present invention, the washer comprises a bevel section of the bottom surface that is shaped to prevent interference with a flange radius.

According to the second aspect of the present disclosure, a threaded fastener tightening apparatus is disclosed. The threaded fastener tightening apparatus includes a folding locking tab having a first tab and a second tab. The first tab and the second tab are movable between a locked position and an unlocked position along an axis transverse to a plane defined by a bendable living hinge. Further, the first tab includes a rotational coupling part in the center of the first tab. The rotational coupling part have a predefined shape allowing rotational coupling and engagement with corners of a nut from a bolted joint for tightening or loosening operation, and a first locking tab slot present on a primary end of the first tab and a second locking tab slot present on a secondary end of the first tab. The second tab includes a lobe in the middle of the second tab. The lobe for rotationally coupling with a self-reacting washer. The second tab also includes a pad associated with the lobe configured to retain the self-reacting washer having mating bevels on the underside of a rotational coupling feature. The second tab also includes a first snap protruded at a first end of the second tab. The first snap is configured to engage and lock with the first locking tab slot when the first tab and the second tab is folded about the bendable living hinge.

According to the third aspect of the present disclosure, a tightening apparatus is disclosed herein. The tightening apparatus comprises a hex nut with an external hex feature. The tightening apparatus further includes a tension control bolt comprises a 12-point rotational coupling feature and an added surface roughness that creates a locking benefit on the underside the head of the tension control bolt. The tightening apparatus also includes a locking cap including a 12-point internal feature for rotationally coupling with the 12-point rotational coupling feature of the tension control bolt. The locking cap comprises an internal hex feature for allowing rotational coupling with the external hex feature of the hex nut.

In an embodiment of the present invention, the tension control bolt comprises a groove for allowing the retention of the locking cap.

In one embodiment of the present invention, the locking cap is molded from a material comprises polymeric, plastic, rubber, and so forth.

The present invention introduces a new apparatus for achieving anti-loosening properties through surface roughness without the inherent drawbacks that friction causes during the torquing of fasteners. Conventional friction based anti-loosening fasteners such as washers, nuts and bolts will utilize surface roughness to resist loosening by creating a rotational coupling with a fixed surface. In order to prevent the rotating fastener from loosening, it is also required to rotationally couple the rotating and sliding surfaces of the fastener to a fixed surface. In doing so, the sliding interfaces will create friction induced efficiency losses while causing surface damage. This disclosure teaches a method of achieving anti-loosing properties by utilizing only a single stationary roughened surface as the foundation for all other anti-loosening couplings in the threaded fastener. It explains how a single roughened surface coupling can then be extended to prevent other mating fasteners from turning. A special washer and bolt are proposed with a surface roughness area only on the static bearing face. After the washer or bolt is loaded through the action of turning a nut, the nut is then rotationally coupled by mechanical means to the washer or bolt through external features and apparatus. Utilization of the apparatus and methods described in this disclosure will provide better anti-loosening benefits from surface roughness features as a result of the reliance on static and loaded interfaces for the foundation of all locking benefits.

The disclosure describes preferred embodiments of the proposed invention. Once the method of using a single static roughened surface as the foundation for mechanically adding anti-loosening devices is understood, many other means of creating the secondary mechanically couplings will become obvious to those skilled in the art. This patent disclosure should be limited by the claim set which covers the foundation for the proposed method and apparatus rather than the small subset of possible embodiments described in the specification.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF DRAWINGS

To describe the technical solutions in the embodiments of the present disclosure or in the prior art more clearly, the following briefly describes the accompanying drawings required for describing the embodiments or the prior art. Apparently, the accompanying drawings in the following description merely show some embodiments of the present disclosure, and a person of ordinary skill in the art can derive other implementations from these accompanying drawings without creative efforts. All of the embodiments or the implementations shall fall within the protection scope of the present disclosure.

FIG. 1 depicts a preferred embodiment of the apparatus of this invention, according to embodiments of the present invention;

FIG. 2 depicts a folding locking tab in the halfway locked position, according to embodiments of the present invention disclosed herein;

FIG. 3 depicts the folding locking tab in the fully locked position, according to embodiments of the present invention disclosed herein;

FIG. 4 depicts folding locking tab prior to engagement with a self-reacting swivel nut, according to embodiments of the present invention disclosed herein;

FIG. 5 depicts folding locking tab engaged with conventional self-reacting swivel nut, according to embodiments of the present invention disclosed herein;

FIG. 6 depicts folding locking tab in the fully locked position while engaged with self-reacting swivel nut, according to embodiments of the present invention disclosed herein;

FIG. 7 depicts folding and underside perspective of folding locking tab in the unlocked position while engaged with self-reacting swivel nut, according to embodiments of the present invention disclosed herein;

FIG. 8 depicts folding locking tab with a hinge created from facets or folds, according to embodiments of the present invention disclosed herein;

FIG. 9 depicts the self-reacting washer viewed from the bottom surface, according to embodiments of the present invention disclosed herein;

FIG. 10 depicts the topside of the self-reacting washer, according to embodiments of the present invention disclosed herein;

FIG. 11 depicts an alternate embodiment of the folding lock tab, according to embodiments of the present invention disclosed herein; and

FIG. 12 depicts a locking cap embodiment of this invention with in half-section view, according to embodiments of the present invention disclosed herein.

The apparatus for tightening threaded fasteners is illustrated in the accompanying drawings, which like reference letters indicate corresponding parts in the various figures. It should be noted that the accompanying figure is intended to present illustrations of exemplary embodiments of the present disclosure. This figure is not intended to limit the scope of the present disclosure. It should also be noted that the accompanying figure is not necessarily drawn to scale.

### DESCRIPTION OF EMBODIMENTS

Those skilled in the art will be aware that the present disclosure is subject to variations and modifications other than those specifically described. It is to be understood that the present disclosure includes all such variations and modifications. The disclosure also includes all such steps, features, compositions and compounds referred to or indicated in this specification, individually or collectively, and any and all combinations of any or more of such steps or features.

The preferred embodiments of this invention will be disclosed in the following descriptions. While some preferred embodiments are described, the disclosure should be limited by the claim set rather than the preferred embodiments utilized to illustrate some of the potential embodiments that this invention disclosure will make obvious to those skilled in the art.

For convenience, before further description of the present disclosure, certain terms employed in the specification, and examples are collected here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”. Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

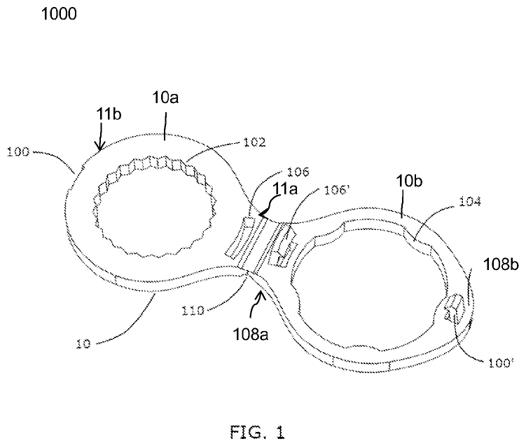

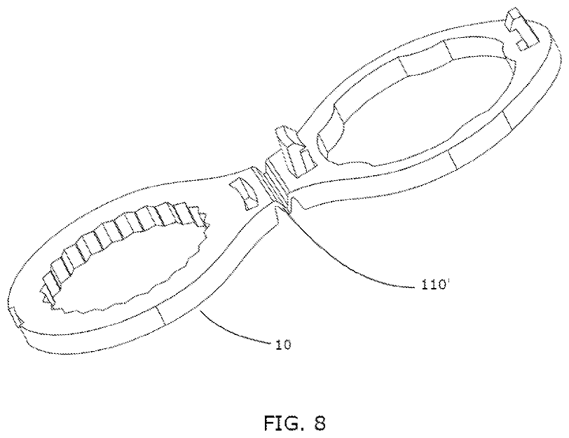

FIGS. 1 to 12 illustrates various views and various embodiments of an apparatus 1000 for tightening threaded fasteners, according to embodiments of the present invention. The apparatus 1000 comprises a folding locking tab 10, a bendable living hinge 110, a rotational coupling part 102, a lobe 104, a first locking tab slot 106, a first snap 106′, a second snap 100′, a nut 12 and so forth.

According to embodiments of the present invention, the folding locking tab 10 may comprise a first tab 10a and a second tab 10b. According to preferred embodiments of the present invention, the folding locking tab 10 may be made of a material comprises a polymeric material such as plastic, rubber, a malleable metal such as aluminum, and so forth.

The first tab 10a and the second tab 10b may be movable between a locked position and an unlocked position along an axis transverse to a plane defined by a bendable living hinge 110. Further, the malleable metal such as aluminum provided may be thin enough to allow folding of the first tab 10a and the second tab 10b.

The first tab 10a comprises the rotational coupling part 102 in the center of the first tab 10a. Further, the rotational coupling part 102 have a predefined shape allowing rotational coupling and engagement with corners of the nut 12 from a bolted joint for tightening or loosening operation.

In an embodiment of the present invention, the predefined shape of the rotational coupling part 102 comprises a plurality of small creases or edges. Further, the nut 12 may comprise only have 6 corners, each of which would interface with one of the creases or edges of the rotational coupling part 102 creating a rotational coupling. Both the rotational coupling part 102 and the lobe 104 may be formed from any shape that may allow the rotational coupling with the nut 12 or washer 14 being engaged. Both the rotational coupling part 102 and the lobe 104 may be formed from a plurality of features allowing for multiple position for a rotational indexing.

In one embodiment, the lobe 104 may be shaped with spline, keys, hexes, squares, or any other feature that may create the rotational coupling between the folding locking tab 10 and the washer 14 with a mating external shape that may not rotate.

The first tab 10a having a first locking tab slot 106 present on a primary end 11a of the first tab 10a and a second locking tab slot 100 present on a secondary end 11b of the first tab 10a.

The second tab 10b having a lobe 104 in the middle of the second tab 10b. Moreover, the lobe 104 comprises a predetermined shape is configured for rotational coupling of the folding locking tab 10 with a washer 14 associated with the nut 12 that includes an interface similar to an interface of the lobe 104. In an embodiment of the present invention, the washer 14 comprises a bevel section 300 of the bottom surface that is shaped to prevent interference with a flange radius.

The second tab 10b having a first snap 106′ protruded at a first end 108a of the second tab 10b. Further, the first snap 106′ is configured to engage and lock with the first locking tab slot 106 when the first tab 10a and the second tab 10b is folded about the bendable living hinge 110.

The apparatus 1000 further comprising a second snap 100′ protruded at a second end 108b of the second tab 10b is configured to engage and lock with the second locking tab slot 100 present on a secondary end 11b of the first tab 10a when the first tab 10a and the second tab 10b is folded about the bendable living hinge 110.

In an embodiment of the present invention, the second end 108b of the second tab 10b is a pronounced or pointed shape that is configured for a rotational positional reference during installation and inspection of the apparatus 1000.

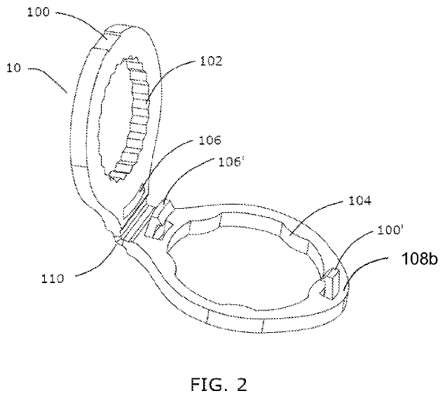

The folding locking tab 10 may be bend in a halfway locked position, as seen in FIG. 2. The second locking tab slot 100, the rotational coupling part 102, the first locking tab slot 106 may be rotated about the bended living hinge item 110 towards the first snap 106′, the lobe 104, the second snap 100′ and the second end 108b of the second tab.

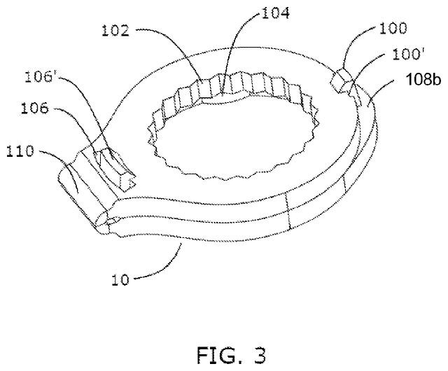

The folding locking tab 10 in the fully locked position is shown in FIG. 3. The first snap 106′ may be engaged in the first locking tab slot 106. The second snap 100′ may be fully engaged in the second locking tab slot 100. The bended living hinge 110 is now fully closed. The bendable living hinge 110 is malleable to allow for rotational indexing of the rotational coupling part 102 in relation to the lobe 104 remaining on the same axis. In one of the preferred embodiment, the bendable living hinge 110 may be created from facets or folds.

The first locking tab slot 106 and the second locking tab slot 100 are configured to allow space for the rotational indexing of the rotational coupling part 102 in relation to the lobe 104. Moreover, the rotational coupling part 102 in the center of the first tab 10a and the lobe 104 in the middle of the second tab 10b are centered about the same axis with rotational coupling features.

The second end 108b of the second tab 10b may allow indication of rotational positioning prior to and after closing of the folding locking tab 10.

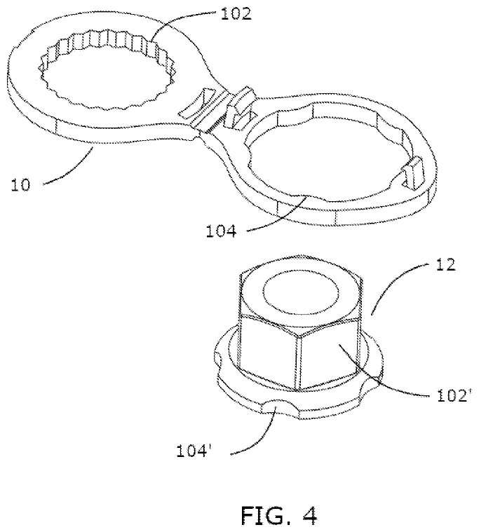

The folding locking tab 10 prior to engagement with a self-reacting swivel nut 12 is shown in FIG. 4. The lobe 104 of folding lock tab 10 may concentrically engage the nut 12 and the lobe 104 may engage with the external feature 104′ of the washer 14 creating a rotational coupling between the folding locking tab 102 and the washer 14 of the self-reacting swivel nut 12. Once folded into the locked position the rotational coupling part 102 of the folding locking tab 10 may engage the hex feature 102′ of the self-reacting swivel nut 12.

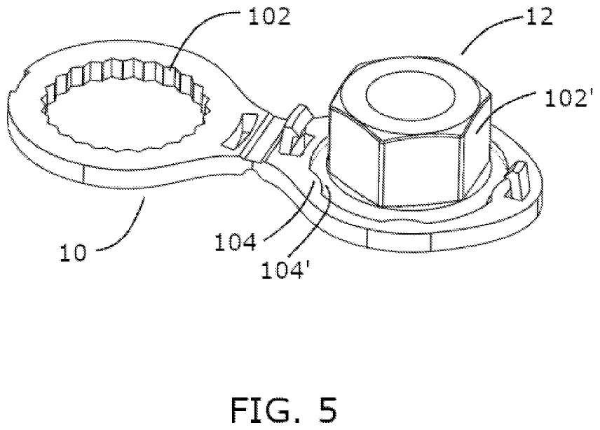

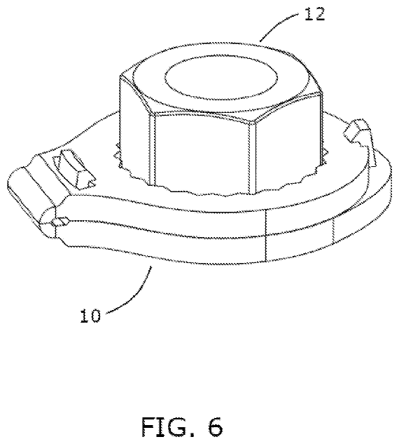

FIG. 5 depicts folding locking tab 10 engaged with the self-reacting swivel nut item 12. The lobe 14 associated with the second tab 10b of the folding locking tab 10 may be engaged with feature the external feature 104′ of the washer 14 of self-reacting swivel nut 12. The folding locking tab 10 is shown in the unlocked position with the rotational coupling part 102 disengaged from the hex feature 102′ of the self-reacting swivel nut 12. The folding locking tab 10 in the fully locked position while engaged with self-reacting swivel nut 12 is particularly seen in FIG. 6.

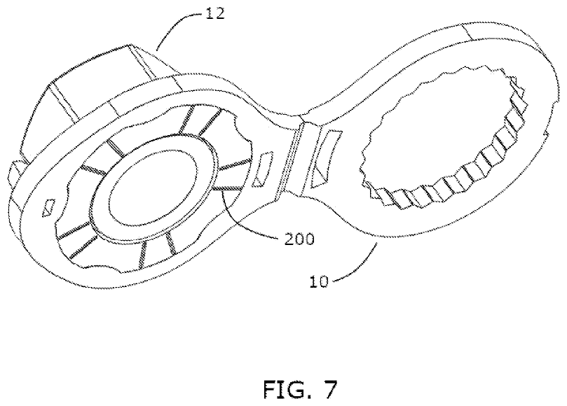

The folding and underside perspective of folding locking tab 10 in the unlocked position while engaged with self-reacting swivel nut 12 is shown in FIG. 7. A typical surface roughness features 200 on the bottom surface of the washer 14 of self-reacting swivel nut 12 is also seen in FIG. 7.

The folding locking tab 10 with the bendable living hinge 110 created from facets or folds 110′. The bendable living hinge 110 is malleable to allow for rotational indexing of the rotational coupling part 102 in relation to the lobe 104 remaining on the same axis. In one of the preferred embodiment, the bendable living hinge 110 may be created from facets or folds.

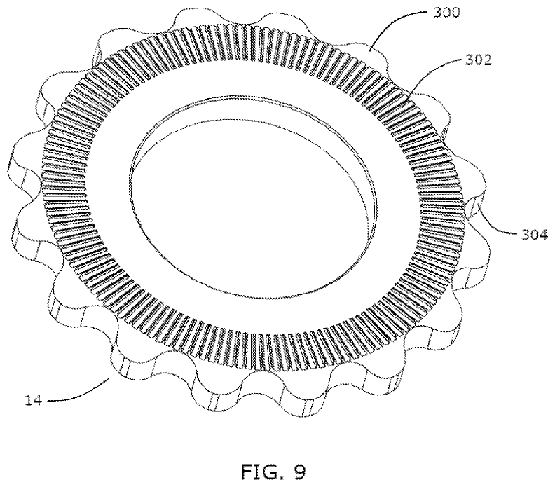

FIG. 9 depicts the self-reacting washer 14 viewed from the bottom surface. Wave shaped lobes 304 are configured for rotational coupling with the apparatus 1000 during the application of torque to the nut 12 or bolt. The wave shaped lobes 304 are a patch of area with increased surface roughness necessary for allowing the washer 14 to become a foundation for reaction torque. In an embodiment of the present invention, the washer 14 comprises the bevel section 300 of the bottom surface that is shaped to prevent interference with a flange radius. When used in conjunction with this invention, the wave shaped lobes 304, protruded sections 302, and the bevel section 300 of the bottom surface of the washer 14 take on new uses. The protruded sections 302 now creates friction that is used for the locking benefit. The wave shaped lobes 304 allows for rotational coupling by mechanical means that is required to pass the protruded sections' 302 locking benefit to the nut 12 or bolts of the fastened connection. The bevel section 300 allows clearance for capturing an external rotational coupling apparatus between the washer 14 and a flange.

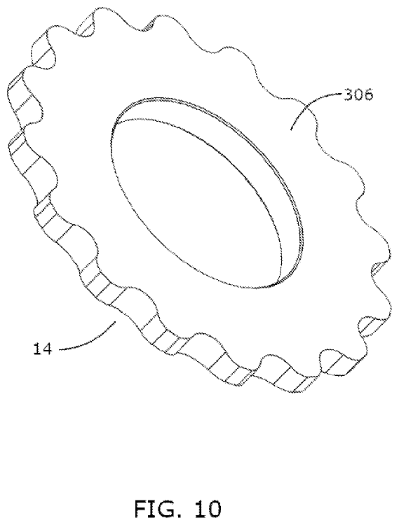

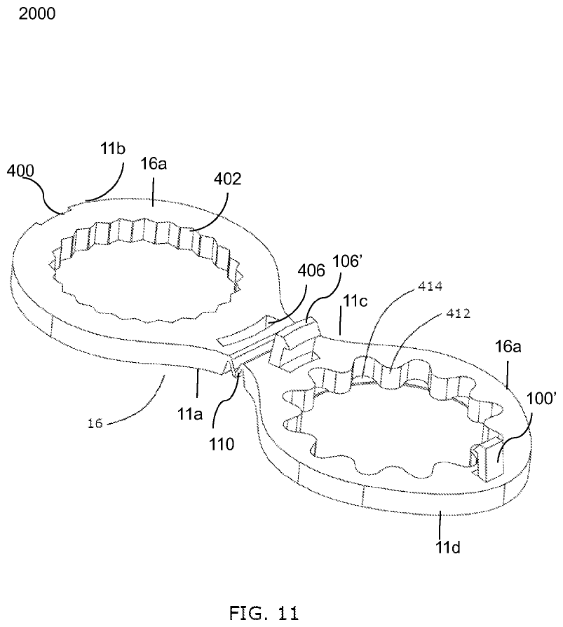

The topside of the self-reacting washer 14 is seen in FIG. 10, the top surface 306 of the self-reacting washer 14 is seen with a smooth surface. Referring to FIG. 11 depicting an alternate embodiment of the threaded fastener tightening apparatus 2000 comprises a folding locking tab 16 having a first tab 16a and a second tab 16b. The first tab 16a and the second tab 16b may be movable between a locked position and an unlocked position along an axis transverse to a plane defined by a bendable living hinge 110.

The first tab 16a including a rotational coupling part 402 in the center of the first tab 10a. Further, the rotational coupling part 402 have a predefined shape allowing rotational coupling and engagement with corners of a nut 12 from a bolted joint for tightening or loosening operation.

The rotational coupling part 402 in the center of the first tab 16a and the lobe 412 in the middle of the second tab 16b are centered about the same axis with rotational coupling features.

In one embodiment, the first tab 16a further includes a first locking tab slot 406 present on a primary end 11a of the first tab 10a and a second locking tab slot 400 present on a secondary end 11b of the first tab 16a.

In one embodiment, the second tab 16b comprises a lobe 412 in the middle of the second tab 10b. The lobe 104 for rotationally coupling with a self-reacting washer 14. The second tab 16b may further comprise a pad 414 associated with the lobe 412 configured to retain the self-reacting washer 14 having mating bevels on the underside of a rotational coupling feature.

The second tab 16b furthermore may comprise a first snap 106′ protruded at a first end 11c of the second tab 16b, the first snap 106′ is configured to engage and lock with the first locking tab slot 406 when the first tab 16a and the second tab 16b is folded about the bendable living hinge 110. The bendable living hinge 110 may be created from facets or folds.

The threaded fastener tightening apparatus 2000 further comprises a second snap 100′ protruded at a second end 11d of the second tab 16b is configured to engage and lock with the second locking tab slot 400 present on a secondary end 11b of the first tab 16a when the first tab 16a and the second tab 16b is folded about the bendable living hinge 110.

Further, the components of the threaded fastener tightening apparatus 2000 are also described above and excluded from further explanation herein for the sake of brevity.

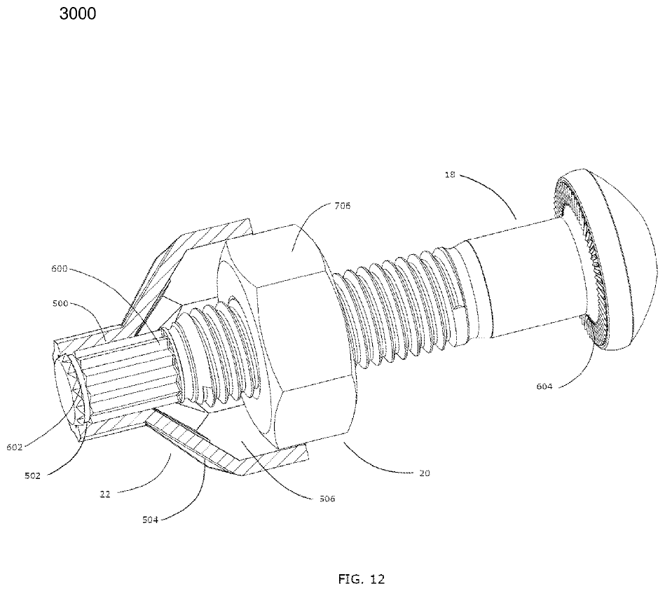

Referring to FIG. 12 depicting a locking cap 22 embodiment of tightening apparatus 3000 is shown. The tightening apparatus 3000 comprises a hex nut 20 with an external hex feature 706.

The tightening apparatus 3000 further comprises a tension control bolt 18 comprises a 12-point rotational coupling feature 600 and an added surface roughness 604 that creates a locking benefit on the underside the head of the tension control bolt 18. In an embodiment of the present invention, the tension control bolt 18 comprises a groove 602 for allowing the retention of the locking cap 22.

The tightening apparatus 3000 further comprises a locking cap 22 including a 12-point internal feature 500 for rotationally coupling with the 12-point rotational coupling feature 600 of the tension control bolt 18.

Further, the locking cap 22 comprises an internal hex feature 506 for allowing rotational coupling with the external hex feature 706 of the hex nut 20. According to embodiments of the present invention, the locking cap 22 is molded from a material comprises polymeric, plastic, rubber, and so forth.

The locking cap 22 may comprise a feature 504 selected from a conically derived thin corrugated, faceted, grooved, ridged, or pleated type of feature to allow for rotational flexibility for overcoming indexing difference between the 12-point rotational coupling feature 600 and the external hex feature 706 of the hex nut 20. In one embodiment, the feature 504 rotationally couples the 12-point internal feature 500 to the internal hexagon section 506 of the locking cap 22.

In one embodiment, the feature's 504 conical shape, material and features allow for rotational flexibility for overcoming indexing difference between the 12-point rotational coupling feature 600 and the external hex feature 706 of the hex nut 20. This flexibility allows for rotationally twisting of feature the 12-point internal feature 500 with respect to the internal hexagon section 506 in order couple when not perfectly aligned. The feature's 504 conical shape, material and features allow for flexibility along the bolt axis allowing for engagement with the 12-point rotational coupling feature 600 when the hex nut 20 is axially closer to the 12-point rotational coupling feature 600.

The locking cap 22 may further comprise an internal ring shape protrusion 502 with chamfered edges on the top and bottom configured to allow axial retention of the locking cap 22 onto the tension control bolt 18 when ample force is applied to snap the internal ring shape protrusion 502 into the groove 602. When fully assembled the tension control bolt 18 is rotationally locked to a stationary bearing face as a result of surface roughness 604. The locking cap 22 then rotationally couples the hex nut 20 to the rotationally locked tension control bolt 18.

While the invention has been described in connection with what is presently considered to be the most practical and various embodiments, it will be understood that the invention is not to be limited to the disclosed embodiments, but on the contrary, is intended to cover various modifications and equivalent arrangements included within the scope of the appended claims.

A person of ordinary skill in the art may be aware that, in combination with the examples described in the embodiments disclosed in this specification, units and algorithm steps may be implemented by electronic hardware, computer software, or a combination thereof.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical software, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the software or implementation without departing from the spirit or scope of the claims of the present technology.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

In a case that no conflict occurs, the embodiments in the present disclosure and the features in the embodiments may be mutually combined. The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed for:

1. An apparatus for tightening threaded fasteners, the apparatus comprising:
a folding locking tab having a first tab and a second tab, the first tab and the second tab are movable between a locked position and an unlocked position along an axis transverse to a plane defined by a bendable living hinge,
the first tab having:
a rotational coupling part in the center of the first tab, the rotational coupling part having a predefined shape allowing rotational coupling and engagement with corners of a nut from a bolted joint for tightening or loosening operation;
a first locking tab slot present on a primary end of the first tab and a second locking tab slot present on a secondary end of the first tab;
the second tab having:
a lobe in the middle of the second tab, the lobe having a predetermined shape is configured for rotational coupling of the folding locking tab with a washer associated with the nut that includes an interface similar to an interface of the lobe;
a first snap protruded at a first end of the second tab, the first snap is configured to engage and lock with the first locking tab slot when the first tab and the second tab is folded about the bendable living hinge.

2. The apparatus of claim 1, further comprising a second snap protruded at a second end of the second tab is configured to engage and lock with the second locking tab slot present on a secondary end of the first tab when the first tab and the second tab is folded about the bendable living hinge.

3. The apparatus of claim 2, wherein the second end of the second tab is a pronounced or pointed shape that is configured for a rotational positional reference during installation and inspection of the apparatus.

4. The apparatus of claim 1, wherein the folding locking tab is made of a material comprises a polymeric material such as plastic, rubber, a malleable metal such as aluminum, or any foregoing combination thereof.

5. The apparatus of claim 1, wherein the predefined shape of the rotational coupling part comprises a plurality of small creases or edges.

6. The apparatus of claim 1, wherein the bendable living hinge is malleable to allow for rotational indexing of the rotational coupling part in relation to the lobe remaining on the same axis.

7. The apparatus of claim 1, wherein the bendable living hinge is created from facets or folds.

8. The apparatus of claim 1, wherein the first locking tab slot and the second locking tab slot are configured to allow space for the rotational indexing of the rotational coupling part in relation to the lobe.

9. The apparatus of claim 1, wherein the rotational coupling part in the center of the first tab and the lobe in the middle of the second tab are centered about the same axis with rotational coupling features.

10. The apparatus of claim 1, wherein the washer comprises a bevel section of the bottom surface that is shaped to prevent interference with a flange radius.

11. A threaded fastener tightening apparatus comprising:
a folding locking tab having a first tab and a second tab, the first tab and the second tab are movable between a locked position and an unlocked position along an axis transverse to a plane defined by a bendable living hinge,
the first tab including a rotational coupling part in the center of the first tab, the rotational coupling part having a predefined shape allowing rotational coupling and engagement with corners of a nut from a bolted joint for tightening or loosening operation, and
a first locking tab slot present on a primary end of the first tab and a second locking tab slot present on a secondary end of the first tab;
the second tab having:
a lobe in the middle of the second tab, the lobe for rotationally coupling with a self-reacting washer;
a pad associated with the lobe configured to retain the self-reacting washer having mating bevels on the underside of a rotational coupling feature;
a first snap protruded at a first end of the second tab, the first snap is configured to engage and lock with the first locking tab slot when the first tab and the second tab is folded about the bendable living hinge.

12. The threaded fastener tightening apparatus of claim 11, further comprising a second snap protruded at a second end of the second tab is configured to engage and lock with the second locking tab slot present on a secondary end of the first tab when the first tab and the second tab is folded about the bendable living hinge.

13. The threaded fastener tightening apparatus of claim 11, the rotational coupling part in the center of the first tab and the lobe in the middle of the second tab are centered about the same axis with rotational coupling features.

14. The threaded fastener tightening apparatus of claim 11, wherein the bendable living hinge is created from facets or folds.

15. A tightening apparatus comprising:
a hex nut with an external hex feature;
a tension control bolt comprises a 12-point rotational coupling feature and an added surface roughness that creates a locking benefit on the underside the head of the tension control bolt; and
a locking cap including a 12-point internal feature for rotationally coupling with the 12-point rotational coupling feature of the tension control bolt, the locking cap comprises an internal hex feature for allowing rotational coupling with the external hex feature of the hex nut.

16. The tightening apparatus of claim 15, wherein the tension control bolt comprises a groove for allowing the retention of the locking cap.

17. The tightening apparatus of claim 15, wherein the locking cap is molded from a material comprises polymeric, plastic, rubber, or any foregoing combination.

18. The tightening apparatus of claim 15, wherein the locking cap comprises a feature selected from a conically derived thin corrugated, faceted, grooved, ridged, or pleated type of feature to allow for rotational flexibility for overcoming indexing difference between the 12-point rotational coupling feature and the external hex feature of the hex nut.

19. The tightening apparatus of claim 18, wherein the feature rotationally couples 12-point internal feature to the internal hexagon section of the locking cap.

20. The tightening apparatus of claim 15, wherein the locking cap comprises an internal ring shape protrusion with chamfered edges on the top and bottom configured to allow axial retention of the locking cap onto the tension control bolt when ample force is applied to snap the internal ring shape protrusion into the groove.
